(19) United States
(12) Patent Application Publication
(10) Pub. No.: US 2021/0364075 A1
(43) Pub. Date: Nov. 25, 2021

(54) Variable torque differential

(71) Applicant: Mr. Leonidas Kyros Kontopoulos, Frankfurt am Main (DE)

(72) Inventors: Konstantinos Kontopoulos, Frankfurt am Main (DE); Grigorios Maximilian Kontopoulos, Frankfurt am Main (DE)

(73) Assignees: Leonidas Kyros Kontopoulos, Frankfurt am Main (DE); Mr. Kyros Philippos Kontopoulos, Frankfurt am Main (DE); Mr. Florentina Magdalena Kontopoulos, Frankfurt am Main (DE)

(21) Appl. No.: 16/991,621

(22) Filed: Aug. 12, 2020

Related U.S. Application Data
(63) Continuation of application No. 16/882,323, filed on May 22, 2020, now abandoned.

(30) Foreign Application Priority Data
May 26, 2020 (EP) 20176520

(51) Int. Cl. F16H 48/10; F16H 57/037; F16H 48/32; F16H 48/34; F16H 48/24

(52) U.S. Cl. CPC F16H 48/10; F16H 57/037; F16H 2057/02052; F16H 48/34; F16H 48/24; F16H 48/32

(57) ABSTRACT

The present invention relates to a variable torque differential, and in particular to an automotive differential, for transferring a rotational force from an input member, for example connected to an automotive engine, to a first and a second output member, for example half-shafts of a drive axle of a vehicle. The differential thereby comprises a first gear connected to the first output member, a second gear connected to the second output member, and at least one third gear system comprising gears and freewheel gears.

### 1. TECHNICAL FIELD

The present invention relates to a differential, in particular an automotive differential, and a vehicle comprising such a differential.

### 2. TECHNICAL BACKGROUND

When a wheeled vehicle, such as an automobile, turns, an outer wheel (i.e. a wheel travelling around the outside of the turning curve) rotates with greater angular velocity compared to an inner wheel, as the outer wheels have to roll further than the inner wheels. For this purpose, a differential is typically applied which allows for the outer wheel to rotate faster than the inner drive wheel during a turn.

The basic differential is the so-called open differential, by which the torque from an engine is equally divided to each wheel. If one wheel faces a slippery surface, the provided torque will easily overcome the available traction at a very low number.

In such case, when having an open differential, the slipping or non-contacting wheel will receive the majority of the power (in the form of low-torque, high rpm rotation), while the contacting wheel will remain stationary with respect to the ground.

Various systems of limited slip differentials have been developed in order to overcome this disadvantage, but all of them use friction elements to create a slip limit and therefore have power losses.

In my invention the torque may be split unequally to the half shafts without any power losses due to friction.

The present invention, which is a mechanical device, provides a solution according to the subject matter of the independent claims.

### 3. SUMMARY OF THE INVENTION

The invention relates to a differential, and in particular to an automotive differential. The differential may thereby allow for transferring a rotational force from an input member (which may be an input shaft or drive shaft connected to an automotive engine) to a first and a second output member (which may be half-shafts of a drive axle).

The differential may also be provided in form of a central differential in AWD or 4WD vehicles, to distribute torques/rotational forces between the front and rear axle.

An exemplary configuration of the variable torque differential, comprises a first gear connected to the first output member, and a second gear connected to the second output member.

The first and the second gears are connected in a rotationally fixed manner to the respective output members. Further, the differential comprises at least one third gear system.

The first gear, the second gear and the third gear system form a sun and planet gear system wherein the first and the second gears form the sun gears of the system and the third gear system forms the planetary gear of the system.

The third gear system comprises at least two gear complex members (sub gear system).

Each gear complex member comprises gears that transfer torque in both directions of rotation and gears that transfer torque only in one direction of rotation.

An exemplary configuration comprises two gears and one dog clutch gear in each gear complex member (three gears per gear complex member).

In each gear complex member, one gear meshes with the assigned first sun gear, one gear meshes with the assigned second sun gear and the remaining gear (intermediate gear) is provided as being coaxially positioned with the one gear and meshes with the other gear.

At least one of the coaxially positioned gears is provided as a dog clutch gear and the gears of the gear complex member that mesh with each other comprise different number of gear teeth in relation to each other.

In the above described exemplary configuration, when the chosen gear ratio of the gears of the gear complex member that mesh with each other is greater than 1, the outer (faster rotating) wheel will have a greater amount of torque in relation to the inner (slower rotating) wheel.

In case the chosen gear ratio of the gears of the gear complex member that mesh with each other is smaller than 1, the inner (slower rotating) wheel will have greater amount of torque in relation to the outer (faster rotating wheel) and as a result a limited slip differential is provided.

Therefore depending on the desired outcome, a suitable gear ratio has to be chosen.

The aspect of a gear ratio non equal to 1 in the gears of the gear complex member of the third gear system that mesh with each other is a key feature of the invention that in combination with the provided dog clutch gear, freewheel gear or overrunning clutch results in a variable torque differential.

In order to provide a limited slip differential, a gear ratio smaller than 1 has to be chosen and at least one of the coaxially positioned gears, in each gear complex member, has to transfer torque in one direction of rotation.

The single torque transferring direction of rotation is achieved by incorporating either freewheel gears or overrunning clutches or other suitable gears that transfer torque in a single direction of rotation or by incorporating axially movable and engageable dog clutch gears.

In this exemplary configuration the axial movement of the gear is achieved by the provision of angled engagement means.

It is going without saying that any type of freewheel gear that by definition transfer torque only in one direction of rotation or overrunning clutch may be used.

Therefore depending on the rotation of the coaxially positioned gear, the axially movable gear is either moved towards the gear that is assigned to be engaged with (and therefore the engagement means interact with both rotating with the same angular velocity) or away from the gear that is assigned to be engaged with (and therefore the engagement means do not interact, with each one rotating interdependently).

In addition a spring or other suitable element may be provided in order to return the axially movable gear to the engaged position (the engagement means of the axially movable gear interact with the engagement means of the gear that the axially movable gear is assigned to be engaged with), when it is moved away.

When a vehicle comprising the proposed differential takes a turn or one wheel faces a slippery surface, one gear complex member is active, and transfers torque while the other is inactive and does not transfer torque (when two gear complex members are being comprised).

In a scenario where one of the two wheels of a vehicle faces a slippery surface, the wheel spins, the gear of the gear complex member that is meshed with the sun gear of the spinning wheel, spins, but due to the fact that it is meshed with the intermediate gear that has more teeth, a greater rotational force acts in the other sun gear, that meshes with the coaxial positioned, to the intermediate gear, axially movable gear.

The intermediate gear, of the other gear complex member rotates interdependently in relation to the assigned coaxial positioned, to the intermediate gear, axially movable gear that is now disengaged.

Therefore the provided torque from the engine does not “escape” to the slipping wheel but is also provided to the wheel with a sufficient amount of traction, according to the chosen gear ratio of the two gears of the gear complex member gear system that mesh with each other.

As it is obvious when two gear complex members are provided, only the one of the two gear complex members becomes active, transferring torque when one of the wheels faces a slippery surface or the vehicle turns.

As mentioned before, the above take place when the intermediate, coaxially positioned in relation to the axially movable gear (driver gear), that meshes with a gear that meshes with an assigned sun gear, has more teeth in relation to the meshed gear (driven gear). Therefore the slower rotating wheel handles greater torque (inner turning wheel).

As a person skilled in the art understands, when the vehicle moves in a straight line, the differential “locks” because all gears of the gear complex members become driver gears.

In addition the exemplary third gear system comprises dog clutch gears but it is going without saying that alternatives obeying the principles of the invention can comprise other types of gears that transfer torque only in one direction of rotation like an electrically or hydraulically freewheel gears.

In an alternative configuration of the proposed differential, the engagement of the two coaxially positioned gears can take place with the help of a hydraulic pump or with the help of an electro magnet.

In that case the intermediate gear that is positioned in a coaxial manner to a planetary gear and meshes with another planetary gear in the same gear complex member, has less gear teeth in relation to the planetary gears.

A Central Processing Unit (CPU) selectively defines which gear complex member will become active (engaged) and which will become inactive (disengaged) by engaging or disengaging the respective intermediate gear.

Depending if the intermediate gear operates as a driver gear or as a driven gear (i.e. if it is engaged or disengaged to the coaxial engageable planetary gear), we may have a differential that the outer turning wheel handles greater torque or a limited slip differential.

The differential further comprises a housing which is engaged by an input member. For example, when the differential is used in a vehicle, the housing receives power from the engine via the drive gear.

As the housing rotates, the rotational force is transferred to the third gear system, and from there to the output members due to the engagement between the first and second gears with the third gear system. It is going without saying that the differential may comprise additional third gear systems.

Another use of the differential of the invention is as a central differential in a vehicle.

As it is well known, when a vehicle takes a turn, the front outer wheel rotates faster than the rear outer wheel and the front inner wheel faster than the rear inner wheel. As a result the gear of the gear complex member that is engaged with the sun gear that transfers torque in the rear differential becomes a driver gear.

Therefore the proposed differential may be used as a central differential in AWD and 4WD vehicles, providing more torque in the front axle when a vehicle turns while moving forward when the intermediate, coaxially positioned in relation to the axially movable gear, gear has less gear teeth in relation to the meshed gear (driver gear has less gear teeth).

In case that the intermediate, coaxially positioned in relation to the axially movable gear, gear has more gear teeth in relation to the meshed gear (driver gear has more gear teeth), when one of the axles (either front or rear) spins, a greater amount of torque will be delivered to the one output member depending on the chosen gear ratio of the meshed gears.

As it is obvious different configurations may be accomplished, achieving different or similar results, but all of these alternatives will obey the basic principles of the invention.

The basic principles of the invention are a third gear system, servicing as a planetary gear system, that comprises gear complex members having gears that transfer torque in both directions of rotation and gears that transfer torque only in one direction of rotation, with the gears of the gear complex member that meshed with each other, having different number of gear teeth in relation to each other.

In addition when the output members rotate with different angular velocities in relation to each other and two gear complex members are being used in the differential, only one gear complex member is active while the other is inactive.

The first and the second gears (sun gears) have an identical number of teeth. In addition, the gears which are meshed with the sun gears have also an identical number of gear teeth with all the gears having the same gear module, with this aspect not being obligatory.

### 4. DESCRIPTION OF PREFERRED EMBODIMENTS

In the following, the present invention will be described with reference to the figures. Therein, similar elements are provided with same reference numbers. It shows:

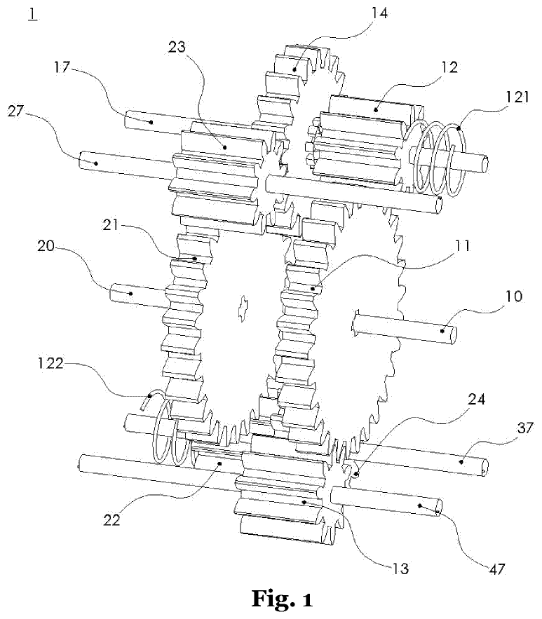

FIG. 1 individual parts of a differential according to the present invention;

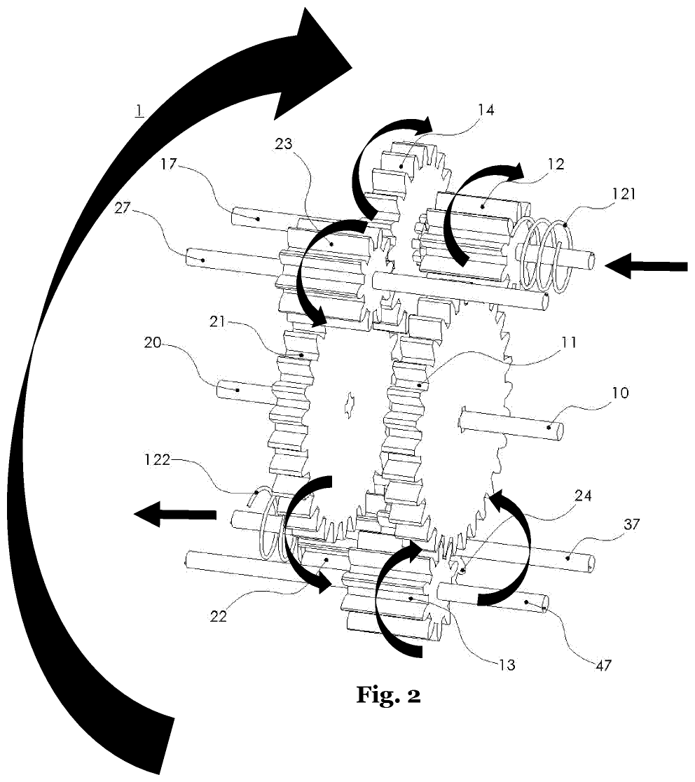

FIG. 2 individual parts of a differential according to the present invention;

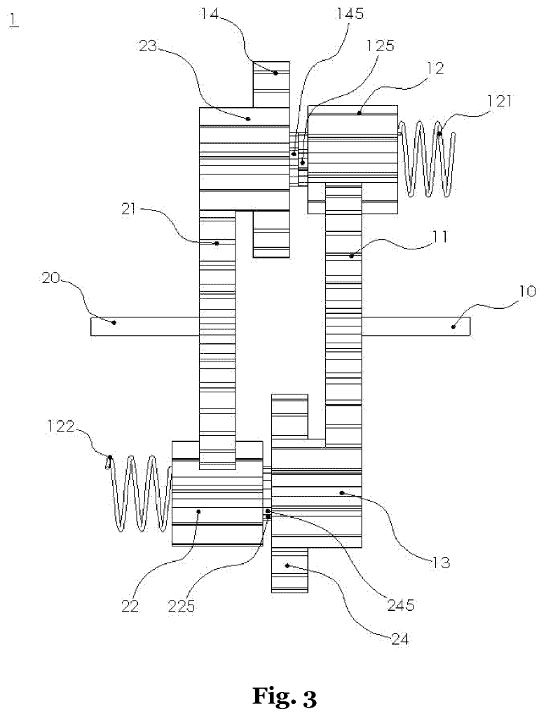

FIG. 3 a side view of individual parts of a differential according to the present invention;

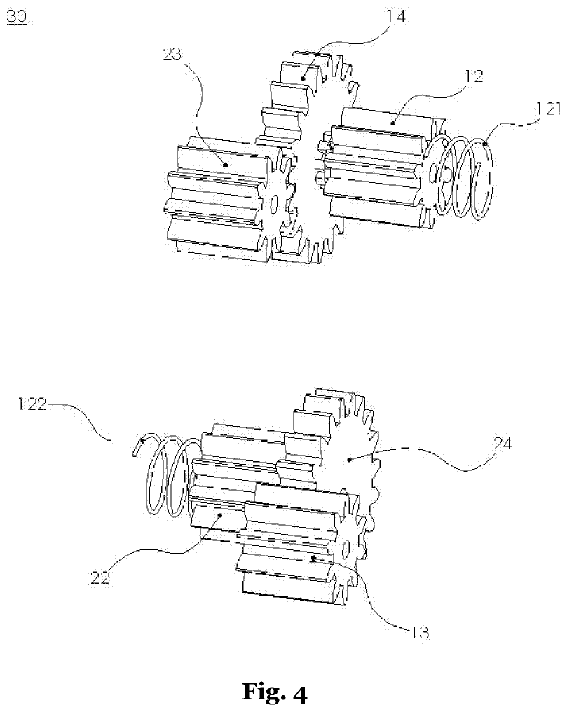

FIG. 4 individual parts of a differential according to the present invention;

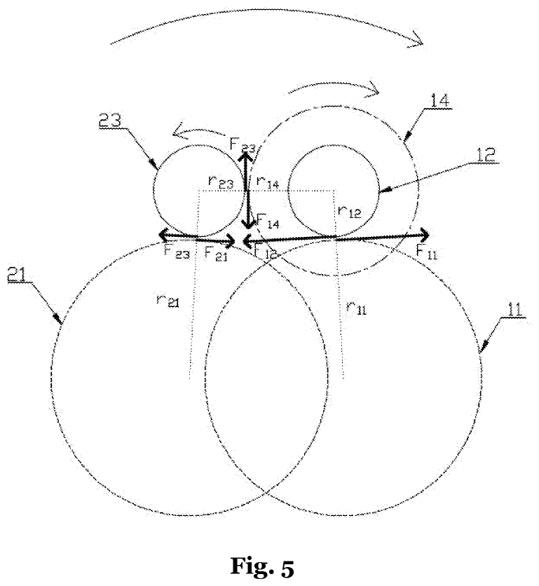

FIG. 5 gives a schematic illustration of the forces acting on the gears according to the present invention;

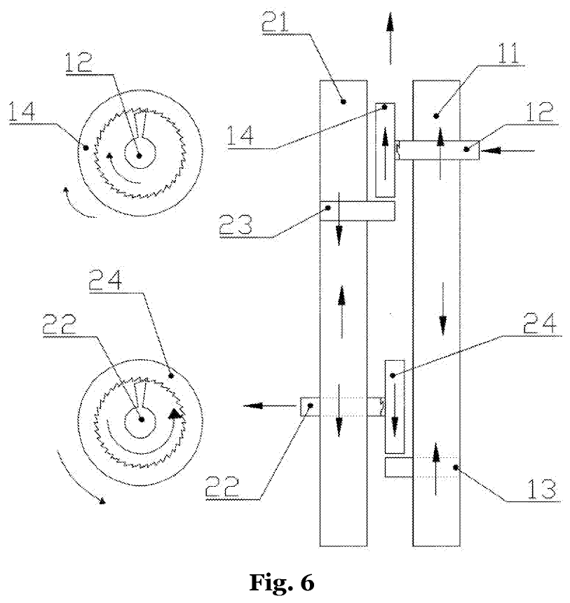

FIG. 6 gives a schematic illustration of the rotational and axial movement of the gears when a wheel faces a slippery surface;

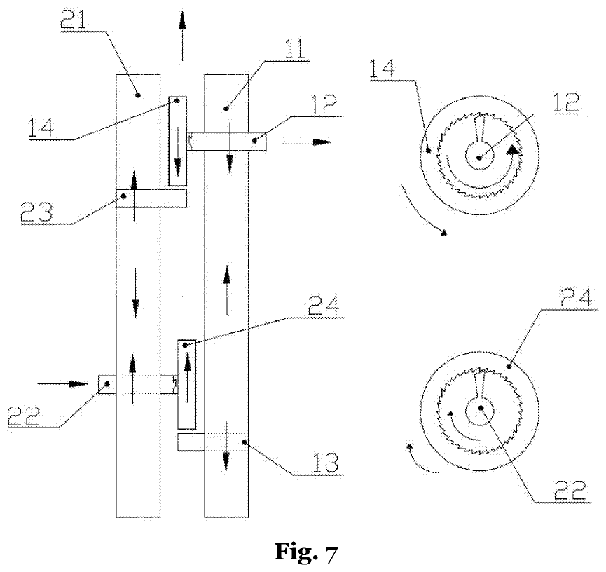

FIG. 7 gives a schematic illustration of the rotational and axial movement of the gears when a wheel faces a slippery surface;

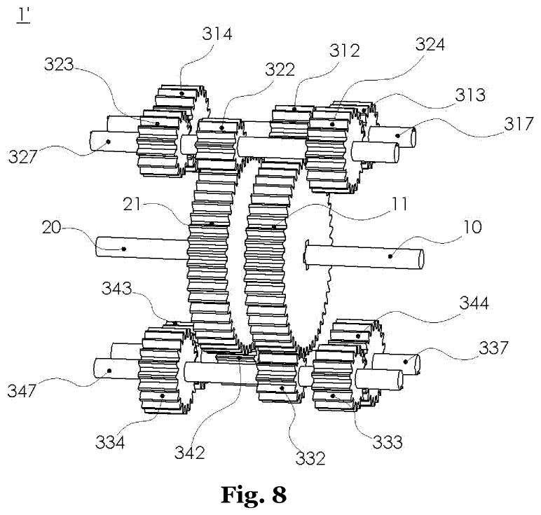

FIG. 8 individual parts of an alternative differential according to the present invention;

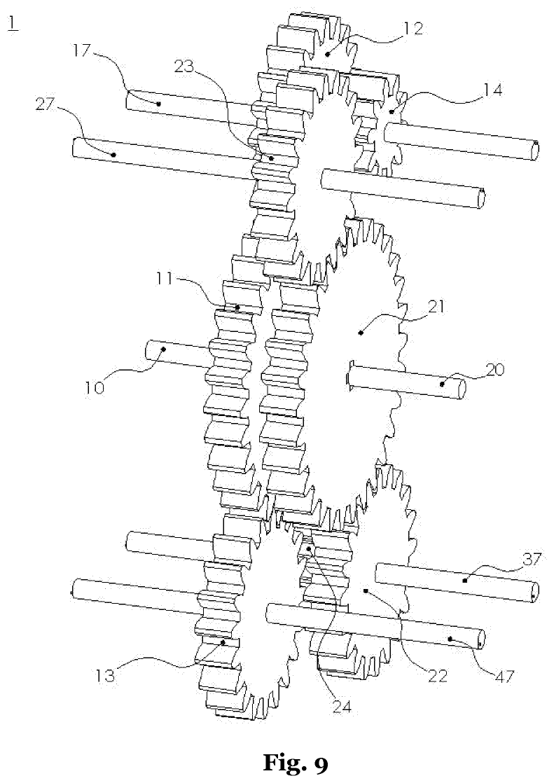

FIG. 9 individual parts of an alternative differential according to the present invention.

FIG. 1 illustrates individual parts of an exemplary differential 1 according to the present invention and in particular the layout of the gears inside the proposed differential 1.

As can be seen the proposed variable torque differential 1 comprises a first gear 11 which is in a rotational fixed manner connected to the assigned output member 10 and a second gear 21 which is in a rotational fixed manner connected to output member 20.

The third gear system is consisted by a first and a second gear complex member.

The first gear complex member comprises two planetary shafts 17, 27.

The planetary shaft 17 supports the axially movable dog clutch gear 12 which meshes with sun gear 11 and the concentrically positioned to the axially movable dog clutch gear 12, intermediate gear 14.

The planetary shaft 27 supports gear 23 which meshes with sun gear 21.

The second gear complex member comprises two planetary shafts 37, 47.

The planetary shaft 37 supports the axially movable dog clutch gear 22 which meshes with sun gear 21 and the concentrically positioned to the axially movable dog clutch gear 22, intermediate gear 24.

It is going without saying that intermediate gears 14, 24 instead of dog clutch gears 12, 22 may be configured as being axially movable.

The first gear 11, the second gear 21 and the third gear system, form a sun and planet gear system with the first and second gears 11, 21 being the sun gears and the gears of the third gear system being the planetary gears.

Gears 13, 23, have less gear teeth in relation to their meshed intermediate gears 14, 24.

Gears 13, 23 and dog clutch gears 12, 22 have the same module and identical number of gear teeth, but this is not restrictive.

Intermediate gears 14, 24 comprise angled engagement means facing the respective coaxially positioned, in relation to the intermediate gears 14, 24, axially movable dog clutch gears 12, 22.

Consequently the coaxially positioned, in relation to the intermediate gears 14, 24, axially movable dog clutch gears 12, 22 comprise angled engagement means facing the respective intermediate gears 14, 24, with the intermediate gears 14, 24 and the respective dog clutch gears 12, 22 being engageable to each other.

When dog clutch gear 12 spins in a clockwise direction (driver gear) engages with the intermediate gear 14 and when dog clutch gear 12 spins in an anticlockwise direction (driven gear) disengages from the intermediate gear 14.

When dog clutch gear 22 spins in a clockwise direction (driver gear) engages with the intermediate gear 24 and when dog clutch gear 22 spins in an anticlockwise direction (driven gear) disengages from the intermediate gear 24.

When a vehicle turns, either the dog clutch gear 12, or the dog clutch gear 22 rotates in a torque transferring direction by being engaged with the respective coaxially positioned intermediate gear 14, 24, resulting in an active (torque transferring) gear complex member while the other gear complex member becomes inactive.

The inactive gear complex member, results in a non torque transferring gear member due to the fact that the corresponding axially movable dog clutch gear, rotates in a non torque transferring direction of rotation because it has been disengaged from the assigned coaxial positioned intermediate gear.

When the output members 10, 20 rotate with the same angular velocity, both the axially movable dog clutch gears 12, 22 are in an engaged position.

In case of a spinning wheel, one of the two axially movable dog clutch gears 12, 22 will be axially moved away from the respective intermediate gear 14, 24, resulting in a disengagement between the two.

When the spinning wheel stops spinning, the corresponding axially movable dog clutch gear 12, 22 will return in an engagement position due to the existence of spring elements 121, 122.

As it is obvious the spring elements secure the engagement of the axially movable dog clutch gears because the engagement means may be provided as being angled. Therefore depending on which of the coaxially positioned gears is configured as being axially movable, the spring elements will be assigned respectively.

The axial movement of the axially movable dog clutch gears 12, 22 is achieved due to existence of angled engagement means.

Alternatively any type of freewheel gear that permits torque transfer in one direction of rotation or overrunning clutch may be used (12 or 14 and 22 or 24).

It is going without saying that intermediate gears 14, 24 may be axially movable instead of dog clutch gears 12, 22, with dog clutch gears 12, 22 being axially fixed in that case.

FIG. 2 illustrates individual parts of an exemplary differential 1 according to the present invention and in particular the layout of the gears inside the proposed differential 1 while one wheel faces a slippery surface, (e.g. the wheel assigned to output member 20).

The arrows show the rotating and the axial directions of individual components.

Therefore as can be seen by the big arrow, the differential rotates in a clockwise direction. Similarly intermediate gear 14, axially movable dog clutch gear 12 and gear 13 rotate also in a clockwise direction.

Intermediate gear 24, axially movable dog clutch gear 22 and gear 23 rotate in an anticlockwise direction.

In addition axially movable dog clutch gear 12 is axially moved towards the coaxially positioned, in relation to the axially movable dog clutch gear 12, intermediate gear 14 and axially movable dog clutch gear 22 is moved away from the coaxially positioned in relation to the axially movable dog clutch gear 22, intermediate gear 24.

As a person skilled in the art understands, axially movable dog clutch gear 12 remains connected in a rotational fixed manner with the assigned coaxially positioned, in relation to the axially movable dog clutch gear 12, intermediate gear 14, while axially movable dog clutch gear 22 is in a non rotational fixed manner connected with the assigned coaxially positioned, in relation to the axially movable dog clutch gear 22, intermediate gear 24 (i.e. rotates interdependently in relation to the intermediate gear 24) due to the fact that it has been axially moved and the engagement means of the two do not interact.

In FIG. 3 a side view of the individual components presented in the previous figures can be seen, with the planetary shafts 17, 27, 37, 47 being omitted for visual purposes.

In this figure the engagement means are visible, with the top gear complex member having a disengaged axially movable dog clutch gear 12 and the bottom gear complex member having an engaged axially movable dog clutch gear 22.

As can be seen the intermediate gear 14 comprises engagement means 145 and the respective axially movable dog clutch gear 12 comprises engagement means 125.

Similarly the intermediate gear 24 comprises engagement means 245 and the respective axially movable dog clutch gear 22 comprises engagement means 225.

In addition since the bottom coaxial couple of gears is presented as being engaged, the respective spring element 122 is decompressed.

Since the top coaxial couple of gears is presented as being disengaged, the respective spring element 121 is compressed.

As mentioned above, only one of the two axially movable dog clutch gears 12, 22 is engaged when the sun gears rotate with different angular velocities.

In FIG. 4 individual parts of the invention are presented and more specifically the two gear complex members that consist the third gear system 30.

As can be seen the third gear system 30 is consisted by two gear complex members, a top one and a bottom one, with the planetary shafts 17, 27, 37, 47 being omitted for visual purposes.

The top gear complex member comprises gear 23, intermediate gear 14 and the coaxially positioned to the intermediate gear 14, axially movable dog clutch gear 12 that can be engaged with the intermediate gear 14.

Respectively, the bottom gear complex member comprises gear 13, intermediate gear 24 and the coaxially positioned to the intermediate gear 24, axially movable dog clutch gear 22 that can be engaged with the intermediate gear 24.

The presented exemplary configuration comprises only one third gear system 30 but it is going without saying that additional third gear systems may be included.

In addition the exemplary third gear system 30 comprises dog clutch gears but it is going without saying that alternatives obeying the principles of the invention can comprise other types of gears that transfer torque only in one direction of rotation like an electrically or hydraulically freewheel gears.

In FIG. 5, a schematic illustration of gear rolling cycles and circumferential forces acting in gears, intermediate gears (that can be freewheel gears or dog clutch gears), axially movable dog clutch gears and sun gears, while one wheel faces a slippery surface, (e.g. wheel assigned to the output member 20), can be seen.

The circumferential forces being presented as arrows, with the arrows on top of the figure representing the direction of rotation of the differential (large top arrow) and the direction of rotation of the planetary gears (smaller arrows).

In addition, sun gears 11, 21 are not illustrated as being coaxial for visual purposes.

The circumferential force F23 equals to the circumferential force F21 (F23=F21) and is equal to the circumferential force F14 (F23=F14).

The equilibrium of torques around the axis (planetary shaft) 17 of rotation is zero (ΣM=0). As result F12=F14*z14/z12, with z12=z23 (z=number of gear teeth).

According to the chosen gear ratio the circumferential force acting on the sun gear of the non slipping wheel is z14/z23 times greater than the circumferential force acting on the sun gear of the slipping wheel.

In FIG. 6 a schematic representation of an exemplary differential according to the present invention can be seen, when the wheel assigned to the sun gear 21 faces a slippery surface.

The gears of the differential are presented as rectangular boxes and the assigned numbers correspond to the parts of the previous figures, with the engagement means of the engageable gears having angled surfaces.

In addition the presented arrows represent the direction of rotation or axial movement of the components.

Furthermore on the left side of the figure a schematic representation of an exemplary alternative of an overrunning clutch (overrunning wheel), can be seen.

In this figure, the angular velocities of the gear complex members are calculated.

The wheel assigned to sun gear 21 faces a slippery surface and dog clutch gear 12 (driver gear) spins with X rpm.

Intermediate gear 14 spins also with X rpm.

Meshed (to the intermediate gear 14) gear 23 spins with (z14/z23)*X rpm, with z14 being the number of gear teeth of the intermediate gear 14 and z23 the number of gear teeth of gear 23, with z14>z23.

Axially movable dog clutch gear 12 remains engaged with the intermediate gear 14.

Gear 13 (driver gear) spins with X rpm.

Intermediate gear 24 spins with (z13/z24)*X rpm, with z24 being the number of gear teeth of the intermediate gear 24 and z13 the number of gear teeth of gear 13, with z24>z13.

Axially movable dog clutch gear 22 spins with (z14/z23)*X rpm, because it meshes with sun gear 21 and as a result will spin with the same rpm as gear 23.

Since z14/z23>z13/z24, axially movable dog clutch gear 22 is moved away from the intermediate gear 24 and disengages.

On the left side of the figure a schematic representation can be seen when overrunning clutches (overrunning wheels), are used. As mentioned before the overrunning clutches (overrunning wheels) is an alternative to the dog clutch gear design.

From the above it is clear that when the sun gears rotate with different angular velocities and the differential comprises two gear complex members, only one gear complex member is active while the other is inactive.

In FIG. 7 an identical schematic representation to the previous figure can be seen but in this figure, the wheel assigned to the sun gear 11 faces a slippery surface.

The wheel assigned to sun gear 11 faces a slippery surface and dog clutch gear 22 (driver gear) spins with X rpm.

Intermediate gear 24 spins also with X rpm, due to the engagement with the axially movable dog clutch gear 22.

Meshed (to the intermediate gear 24) gear 13 spins with (z24/z13)*X rpm, with z24 being the number of gear teeth of the intermediate gear 24 and z13 the number of gear teeth of gear 13, with z24>z13.

Axially movable dog clutch gear 22 moves towards the intermediate gear 24 and remains engaged.

Axially movable dog clutch gear 12 spins as does gear 13 due to the fact that they both mesh with sun gear 11.

Therefore axially movable dog clutch gear 12 spins with (z24/z13)*X rpm.

Gear 23 meshes with sun gear 21 and spins with X rpm.

Intermediate gear 14, which meshes with gear 23, spins with (z23/z14)*X rpm, with z14 being the number of gear teeth of the intermediate gear 14 and z23 the number of gear teeth of gear 23, with z14>z23.

z14/z23=z24/z13>1>z23/z14

Therefore axially movable dog clutch gear 12 spins faster than intermediate gear 14 and as a result it disengages.

On the right side of the figure a schematic representation can be seen when overrunning clutches (overrunning wheels), are used. As mentioned before the overrunning clutches (overrunning wheels) is an alternative to the dog clutch gear design.

From the above it is clear that when the sun gears rotate with different angular velocities and the differential comprises two gear complex members, only one gear complex member is active while the other is inactive.

FIG. 8 illustrates individual parts of an exemplary alternative differential 1′ according to the present invention.

In this alternative exemplary configuration, the layout of the gears inside the differential 1′ can be seen.

As can be seen a first gear 11 is in a rotational fixed manner connected to the assigned output member 10 and a second gear 21 which is in a rotational fixed manner connected to output member 20.

This proposed configuration comprises two third gear system that serve as planetary gears to the first and second gears 11, 21 which are the sun gears in this configuration, but as it is obvious additional third gear systems can be adopted.

Each third gear system is consisted by a first and a second gear complex member.

The top third gear system comprises planetary shafts 317, 327.

Planetary shaft 317 supports right gear 313, planetary gear 312 and left gear 314, and is the first gear complex member of the top third gear system.

Planetary shaft 327 supports right gear 324, planetary gear 322 and left gear 323, and is the second gear complex member of the top third gear system.

As can be seen left gear 314 meshes with left gear 323, and right gear 313 meshes with right gear 324.

In addition planetary gear 312 meshes with the assigned sun gear 11 and planetary gear 322 meshes with the assigned sun gear 21.

The bottom third gear system comprises planetary shafts 337, 347.

Planetary shaft 337 supports right gear 344, planetary gear 342 and left gear 343, and is the first gear complex member of the bottom third gear system.

Planetary shaft 347 supports right gear 333, planetary gear 332 and left gear 334, and is the second gear complex member of the bottom third gear system.

As can be seen right gear 344 meshes with right gear 333, and left gear 343 meshes with left gear 334.

In addition planetary gear 322 meshes with the assigned sun gear 11 and planetary gear 342 meshes with the assigned sun gear 21.

As it is apparent, each gear complex member comprises gears that mesh with the gears of the other gear complex member of the same third gear system. These meshing gears comprise different number of gear teeth in relation to each other.

Each gear complex member comprises a freewheel gear or an overrunning clutch that can be either a left gear, a right gear or a planetary gear.

In addition when freewheel gears or overrunning clutches are used, all of the supported gears of the planetary shafts are torque proof connected to the respective planetary shafts, but as it is apparent when a gear is a freewheel gear or an overrunning clutch, the torque proof connection with the planetary shaft is in only one direction of rotation.

Obeying the previous mentioned principles of the invention, the gears that mesh with each other have different number of gear teeth in relation to each other.

In case a limited slip design is desired an axially movable gear is also possible with this alternative.

Therefore in this exemplary configuration, the planetary gears 312, 322, 332, 342 may be adopted as dog clutch gears, being axially movable and engageable to the respective, coaxially positioned gears 313, 323, 333, 343, or vice versa.

As a person skilled in the art understands, the axially movable dog clutch gears are not torque proof connected to the respective planetary shafts, but the torque proof connection takes place via the interaction of the engagement means between the engageable gears.

From the above it is made clear that although the design approach of the alternative differs in the coaxial position of every gear of each gear complex member, the principles of the innovation are the same and so are the desired outcomes (variation of torque among the output members and no spinning output member).

FIG. 9 presents individual parts of an exemplary alternative differential 1 according to the present invention.

In this alternative a Central Processing Unit (CPU) selectively commands the axially movable gear to be driven or driver gear, by engaging or disengaging the corresponding engageable gears of the corresponding gear complex member.

The configuration is similar to the one presented in FIG. 1, but in this exemplary alternative, intermediate gears 14, 24 are configured to be axially movable. As mentioned before either one of the coaxially positioned gears of each gear complex member can be configured as being axially movable.

In addition the intermediate gears 14, 24 have less gear teeth in relation to their meshed gears 13, 23.

The engagement means of the engageable gears (planetary gears 12, 22 and axially movable intermediate gears 14, 24) may comprise angled surfaces in order to facilitate the disengagement of the two.

A hydraulic pump or an electro magnetic coil controls the axial position of the axially movable intermediate gears 14, 24 and therefor the engageable gears (planetary gear 12—axially movable intermediate gear 14 and planetary gear 22—axially movable intermediate gear 24) are engaged or disengaged.

As a result, intermediate gears 14, 24 can be chosen to be either driver gears or driven gears and consequently, a limited slip differential or a differential that the outer turning wheel handles greater torque can be achieved.

When a vehicle comprising the proposed differential takes a turn or one wheel faces a slippery surface, one gear complex member is active while the other is inactive.

For example in this configuration, when sun gear 11 spins and the upper gear member is active and the other is inactive, we have a limited slip differential.

Similarly (gear complex members being active/inactive as above) when the vehicle takes a turn and the output member 10 is the half shaft of the inner wheel, the outer wheel will handle greater torque.

Therefore it is made clear that different outcomes may be achieved, depending on which intermediate gear is driver gear or driven gear.

Additionally a spring or any other suitable elastic element can be incorporated in addition to the axial controlling means (hydraulic pump or electro magnet) in order to assist the engagement of the engageable gears, with the spring or the other suitable elastic element being assigned to the axially movable gear.

From the above, it is made clear that depending on the desired outcome many configurations are possible with the presented configurations being exemplary and not restrictive.

### LIST OF REFERENCE SIGNS

1 differential
10 first output member
11 first gear/sun gear
12 planetary gear/dog clutch gear
13 gear/planetary gear
14 intermediate gear
17 planetary shaft
20 second output member
21 second gear/sun gear
22 planetary gear/dog clutch gear
23 gear/planetary gear
24 intermediate gear
27 planetary shaft
30 third gear system
37 planetary shaft
47 planetary shaft
121 spring element
122 spring element
125 engagement means
145 engagement means
225 engagement means
245 engagement means
312 gear/planetary gear
313 gear
314 intermediate gear
317 planetary shaft
322 gear/planetary gear
323 gear
324 gear
327 planetary shaft
332 gear/planetary gear
333 gear
334 gear
337 planetary shaft
342 gear/planetary gear
343 gear
344 gear
347 planetary shaft

1. Differential, in particular an automotive differential, for transferring a rotational force from an input member to a first and a second output member, comprising:
a first gear connected to the first output member;
a second gear connected to the second output member; and
at least one third gear system engaging both the first and second gears, wherein the third gear system comprises gears and freewheel gears.

2. The differential according to claim 1,
wherein the freewheel gears of the third gear system can be overrunning clutches or engageable and axially movable dog clutch gears.

3. The differential according to any one of claims 1 to 2,
wherein the first gear, the second gear and the third gear system form a sun and planetary gear system;
wherein the third gear system is provided as a planetary gear, and
wherein the first gear and the second gear are provided as sun gears.

4. The differential according to claim 3, further comprising a housing engageable by the input member;
wherein the housing supports the at least one third gear system;
wherein the at least one third gear system comprises a first gear complex member and a second gear complex member;
wherein the gears of each gear complex member that mesh with each other comprise different number of gear teeth.

5. The differential according to claim 4
wherein each gear complex member comprises three gears, a first gear, a second gear and an intermediate gear;
wherein the first gear and the intermediate gear are provided in a coaxial manner;
wherein the first gear of each gear complex member meshes with an assigned sun gear and the second gear of each gear complex member meshes with another assigned sun gear;
wherein the intermediate gear meshes with the second gear;
wherein one of the coaxially positioned gears of each gear complex member is provided as a freewheel gear or an overrunning clutch.

6. The differential according to claim 4
wherein each gear complex member comprises three gears, a first gear, a second gear and an intermediate gear;
wherein the first gear and the intermediate gear are provided in a coaxial manner;
wherein the first gear of each gear complex member meshes with an assigned sun gear and the second gear of each gear complex member meshes with another assigned sun gear;
wherein the intermediate gear meshes with the second gear;
wherein one of the coaxially positioned gears of each gear complex member is provided as an axially movable dog clutch gear;
wherein the axially movable dog clutch gear is configured as being engageable to the other coaxially positioned gear;
wherein the two engageable, coaxially positioned gears of each gear complex member comprise an engagement system in order to be engaged to each other.

7. The differential according to claim 3, further comprising a housing engageable by the input member;
wherein the housing supports the at least one third gear system;
wherein the at least one third gear system comprises a first gear complex member and a second gear complex member;
wherein the gears of the two gear complex members that mesh with each other comprise different number of gear teeth.

8. The differential according to claim 7
wherein each gear complex member comprises three gears, a left gear, a planetary gear and a right gear;
wherein all of the gears of each gear complex member are provided in a coaxial manner;
wherein the planetary gears of each gear complex member mesh with an assigned sun gear;
wherein the left gears of the first gear complex member mesh with the left gears of the second gear complex member;
wherein the right gears of the first gear complex member mesh with the right gears of the second gear complex member;
wherein one of the coaxially positioned gears of each gear complex member is provided as a freewheel gear or an overrunning clutch.

9. The differential according to claim 7
wherein each gear complex member comprises three gears, a left gear, a planetary gear and a right gear;
wherein all of the gears of each gear complex member are provided in a coaxial manner;
wherein the planetary gears of each gear complex member mesh with an assigned sun gear;
wherein the left gears of the first gear complex member mesh with the left gears of the second gear complex member;
wherein the right gears of the first gear complex member mesh with the right gears of the second gear complex member;
wherein one of the coaxially positioned gears of each gear complex member is provided as an axially movable dog clutch gear;
wherein each axially movable dog clutch gear is configured as being engageable to another coaxially positioned gear;
wherein the two engageable, coaxially positioned gears of each gear complex member comprise an engagement system in order to be engaged to each other.

10. The differential according to claim 6 or claim 9
wherein axial controlling systems, that can be hydraulic or electromagnetic systems, are provided in order to control the axial movement of the axially movable dog clutch gears;
wherein a Central Processing Unit is provided in order to control the axial controlling systems.

11. The differential according to claim 6, claim 9 or claim 10
wherein at least one elastic element is provided in each axially movable dog clutch gear.

12. Method for operating a differential according to any one of the preceding claims:
wherein selectively from each third gear system, one gear complex member is active and one is inactive.

13. Vehicle comprising a differential according to any one of claims 1 to 11.
